(19) United States
(12) Patent Application Publication
(10) Pub. No.: US 2008/0140446 A1
(43) Pub. Date: Jun. 12, 2008

(54) SYSTEM AND METHOD FOR MANAGING MEDICAL RECORDS

(75) Inventors: Ken H. Rosenfeld, Pittsford, NY (US); Michael J. Margiotta, Victor, NY (US)

Correspondence Address: HOLLAND & KNIGHT LLP, 10 ST. JAMES AVENUE, 11th Floor, BOSTON, MA, 02116-3889, US

(73) Assignee: eHealth Global Technologies, Rochester, NY (US)

(21) Appl. No.: 11/609,034

(22) Filed: Dec. 11, 2006

(51) Int. Cl. G06Q 50/00

(52) U.S. Cl. 705/2

(57) ABSTRACT

A method of managing medical records includes preparing, on behalf of a second medical services provider, a request for one or more medical records from a first medical services provider. The request is provided to the first medical services provider. The one or more medical records are obtained from the first medical services provider. The availability of the one or more medical records is enabled for the second medical services provider.

### TECHNICAL FIELD

This disclosure relates to medical records and, more particularly, to the management of medical records.

### BACKGROUND

Patients are often treated by a multiplicity of medical professionals. For example, a patient may use a general practitioner for routine medical care. Additionally, the patient may use several specialized practitioners to treat various ailments. Examples of such specialized practitioners may include but are not limited to rheumatologists, cardiologists, and oncologists.

Often, when a patient is referred to a specialized practitioner from a general practitioner, the specialized practitioner may request a copy of the various medical records concerning the patient. For example, if the general practitioner referred the patient to a cardiologist due to the patient failing a stress test, the cardiologist may request a copy of the medical records associated with the stress test so that the patient does not have to undergo duplicative testing procedures.

Typically, the responsibility of obtaining copies of the patient's medical records is often placed on an administrator or assistant within the office of the specialized practitioner. Unfortunately, this task often proves difficult due to the high existing workloads of administrators/assistants and the lack of existing business relationships between the office of the specialized practitioner and the office of the general practitioner.

The responsibility for obtaining copies of the patient's medical records may also fall on the patient. This can cause significant additional stress to the patient, particularly since it is during a time of ill health. Furthermore, patients typically do not have the training to validate that the records they are collecting are the correct ones, and if they show up at the specialized practitioner without their records, or the incorrect ones, they may have to cancel the appointment and reschedule, causing further stress to the patient, and unrecoverable costs to the specialist.

### SUMMARY OF THE DISCLOSURE

In a first implementation of this disclosure, a method of managing medical records includes preparing, on behalf of a second medical services provider, a request for one or more medical records from a first medical services provider. The request is provided to the first medical services provider. The one or more medical records are obtained from the first medical services provider. The availability of the one or more medical records is enabled for the second medical services provider.

One or more of the following features may be included. The request may be an electronic request and providing the request may include sending the electronic request to the first medical services provider. The request may be a paper-based request and providing the request may include sending the paper-based request to the first medical services provider.

The one or more medical records may include one or more text-based medical records, one or more image-based medical records, and/or one or more computer file-based medical records. Enabling the availability may include enabling the availability of an electronic copy of the one or more medical records to the second medical services provider. The electronic copy of the one or more medical records may be streamed to the second medical services provider. The second medical services provider may be notified of the availability of the one or more medical records obtained from the first medical services provider.

Notifying the second medical services provider may include providing the second medical services provider with a link to an electronic copy of the one or more medical records. The first medical services provider may be a general clinician. The second medical services provider may be a specialized clinician.

In another implementation of this disclosure, a method of managing medical records includes preparing, on behalf of a second medical services provider, a request for one or more medical records from a first medical services provider. The request is provided to the first medical services provider. The one or more medical records are obtained from the first medical services provider. The availability of an electronic copy of the one or more medical records is enabled for the second medical services provider.

One or more of the following features may be included. The second medical services provider may be notified of the availability of the electronic copy of the one or more medical records obtained from the first medical services provider. Notifying the second medical services provider may include providing the second medical services provider with a link to the electronic copy of the one or more medical records. The electronic copy of the one or more medical records may be streamed to the second medical services provider.

In another implementation of this disclosure, a method of managing medical records includes preparing, on behalf of a second medical services provider, a request for one or more medical records from a first medical services provider. The request is provided to the first medical services provider. The one or more medical records are obtained from the first medical services provider. The second medical services provider is notified of the availability of the one or more medical records obtained from the first medical services provider.

One or more of the following features may be included. The request may be an electronic request and providing the request may include sending the electronic request to the first medical services provider. The request may be a paper-based request and providing the request may include sending the paper-based request to the first medical services provider. The availability of the one or more medical records may be enabled for the second medical services provider. Notifying the second medical services provider may include providing the second medical services provider with a link to an electronic copy of the one or more medical records.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a record management process executed in whole or in part by a computer coupled to a distributed computing network;

FIG. 2 is a flowchart of the record management process of FIG. 1;

FIG. 3 is a diagrammatic view a cellular telephone configured to access the record management process of FIG. 1; and

FIG. 4 is a diagrammatic view of a personal digital assistant configured to access the record management process of FIG. 1.

### DETAILED DESCRIPTION OF THE PREFERRED EMBODIMENTS

### System Overview:

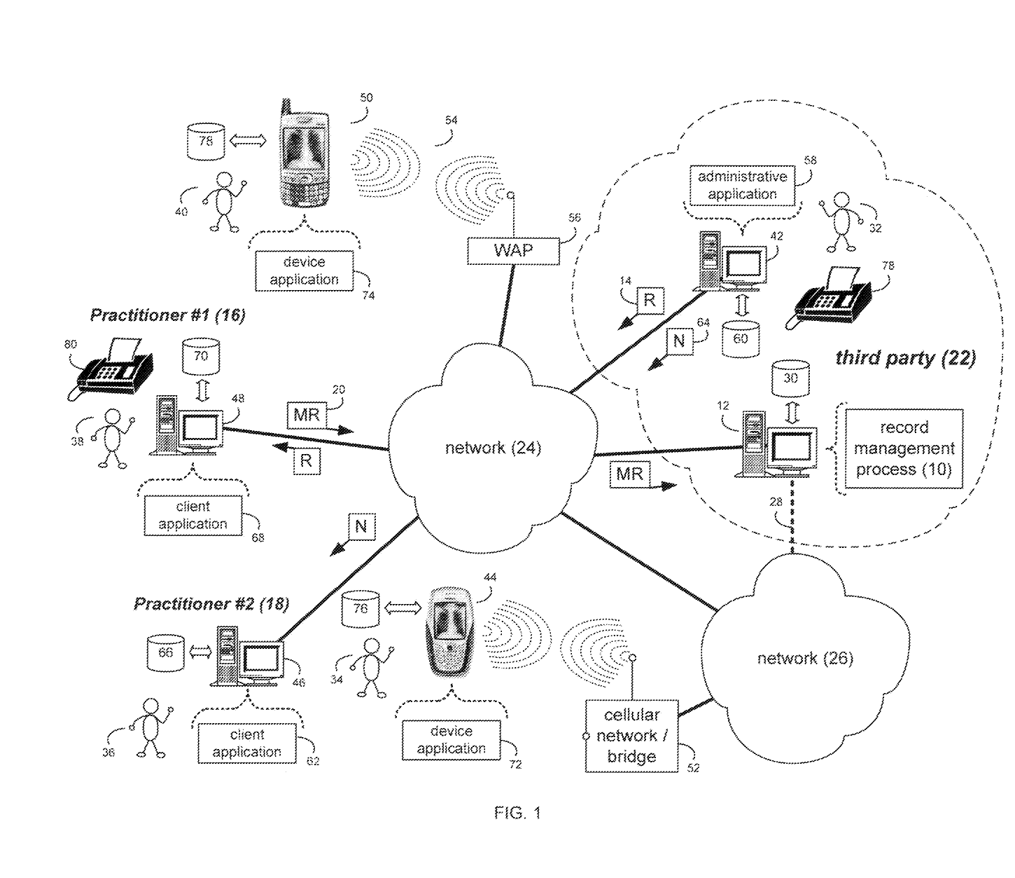

Referring to FIG. 1, there is shown a record management process 10, which may be a server-based application resident on (in whole or in part) and executed by (in whole or in part) computer 12 (e.g., a single server computer, a plurality of server computers, or a general purpose computer, for example). As will be discussed below in greater detail, record management process 10 may allow for a request 14 to be made of a first practitioner 16, on behalf of a second practitioner 18, requesting that the first practitioner 16 provide a copy of a patient's medical records 20 to a third party 22, so that the third party 22 can make the copy of the medical records 20 available to the second practitioner 18.

Computer 12 may be coupled to network 24 (e.g., the Internet). Computer 12 may be, for example, a web server running a network operating system, examples of which may include but are not limited to Microsoft Windows XP Server™, or Redhat Linux™.

Computer 12 may also execute a web server application, examples of which may include but are not limited to Microsoft IIS™, or Apache Webserver™, that allows for HTTP (i.e., HyperText Transfer Protocol) access to computer 12 via network 24. Network 24 may be coupled to one or more secondary networks (e.g., network 26), such as: a local area network; a wide area network; or an intranet, for example. Additionally/alternatively, computer 12 may be coupled to network 24 through secondary network 26, as illustrated with phantom link line 28.

The instruction sets and subroutines of record management process 10, which may be stored on a storage device 30 coupled to computer 12, may be executed by one or more processors (not shown) and one or more memory architectures (not shown) incorporated into computer 12. Storage device 30 may include but are not limited to a hard disk drive, a tape drive, an optical drive, a RAID array, a random access memory (RAM), or a read-only memory (ROM).

Users 32, 34, 36, 38, 40 may access record management system 10 (directly through network 24 or through secondary network 26) using various client electronic devices, examples of which may include but are not limited to: administrative computer 42, data-enabled cellular telephone 44, client computer 46, client computer 48, personal digital assistant 50, laptop computers (not shown), and dedicated network appliances (not shown), for example.

The various client electronic devices may be directly or indirectly coupled to network 24 (or network 26). For example, administrative computer 44, and client computers 46, 48 are shown directly coupled to network 24 via hardwired network connections. Additionally, cellular telephone 44 is shown wirelessly coupled to cellular network/bridge 52, which is shown directly coupled to network 26. Further, personal digital assistant 50 is shown wirelessly coupled to network 24 via a wireless communication channel 54 established between personal digital assistant 50 and wireless access point (i.e., WAP) 56, which is shown directly coupled to network 24.

WAP 56 may be, for example, an IEEE 802.11a, 802.11b, 802.11g, Wi-Fi, and/or Bluetooth device that is capable of establishing secure communication channel 54 between personal digital assistant 50 and WAP 56.

As is known in the art, all of the IEEE 802.11x specifications use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Client Software:

Administrative computer 42 may execute an administrative application 58, examples of which may include but are not limited to a web browser application (e.g., Microsoft Internet Explorer™ and Netscape Navigator™), an email client (Microsoft Outlook™, Lotus Notes™, and Novell Groupwise™) or a specialized interface that allows e.g., user 32 to access and configure record management system 10 and generate and provide request 14 to first practitioner 16 via network 24 (and/or network 26). Administrative computer 42 may execute an operating system, examples of which may include but are not limited to Microsoft Windows XP™ or Redhat Linux™.

The instruction sets and subroutines of administrative application 58, which may be stored on a storage device 60 coupled to administrative computer 42, may be executed by one or more processors (not shown) and one or more memory architectures (not shown) incorporated into administrative computer 42. Storage device 60 may include but are not limited to a hard disk drive, a tape drive, an optical drive, a RAID array, a random access memory (RAM), or a read-only memory (ROM).

Client computer 46 may execute a client application 62, examples of which may include but are not limited to a web browser application (e.g., Microsoft Internet Explorer™ and Netscape Navigator™, an email client (Microsoft Outlook™, Lotus Notes™, and Novell Groupwise™), a data viewing application (e.g., Citrix Access Gateway™) or a specialized interface that allows e.g., user 36 to access record management system 10, receive notification 64 (to be discussed below in greater detail) and view medical records 20 stored on e.g., computer 12 (via network 24 and/or network 26). Client computer 46 may execute an operating system, examples of which may include but are not limited to Microsoft Windows XP™ or Redhat Linux™.

The instruction sets and subroutines of client application 62, which may be stored on a storage device 66 coupled to client computer 46, may be executed by one or more processors (not shown) and one or more memory architectures (not shown) incorporated into client computer 46. Storage device 66 may include but are not limited to a hard disk drive, a tape drive, an optical drive, a RAID array, a random access memory (RAM), or a read-only memory (ROM).

Client computer 48 may execute a client application 68, examples of which may include but are not limited to a web browser application (e.g., Microsoft Internet Explorer™ and Netscape Navigator™), an email client (Microsoft Outlook™, Lotus Notes™, and Novell Groupwise™), or a specialized interface that allows e.g., user 38 to access record management system 10, receive request 14 from e.g., administrative computer 42, and provide medical records 20 to computer 12 (via network 24 and/or network 26). Client computer 48 may execute an operating system, examples of which may include but are not limited to Microsoft Windows XP™ or Redhat Linux™.

The instruction sets and subroutines of client application 68, which may be stored on a storage device 70 coupled to client computer 48, may be executed by one or more processors (not shown) and one or more memory architectures (not shown) incorporated into client computer 48. Storage device 70 may include but are not limited to a hard disk drive, a tape drive, an optical drive, a RAID array, a random access memory (RAM), or a read-only memory (ROM).

Cellular telephone 44 and/or personal digital assistant 50 may execute a client application 72, 74 (respectively), examples of which may include but are not limited to a web browser application (e.g., Microsoft Internet Explorer™ and Netscape Navigator™), an email client (Microsoft Outlook™, Lotus Notes™, and Novell Groupwise™), a data viewing application (e.g., Citrix Access Gateway™), or a specialized interface that allows e.g., user 34, 40 (respectively) to access record management system 10, receive notification 64 (to be discussed below in greater detail) and view medical records 20 stored on e.g., computer 12 (via network 24 and/or network 26). Cellular telephone 44 and/or personal digital assistant 50 may execute an operating system, examples of which may include but are not limited to Microsoft Windows Mobile™, Redhat Linux™, Palm OS™, or a device-specific (i.e., custom) operating system.

The instruction sets and subroutines of client application 72, 74, which may be stored on a storage device 76, 78 (respectively) coupled to cellular telephone 44 and/or personal digital assistant 50 (respectively), may be executed by one or more processors (not shown) and one or more memory architectures (not shown) incorporated into cellular telephone 44 and/or personal digital assistant 50. Storage device 76, 78 may include but are not limited to a hard disk drive, a tape drive, an optical drive, a RAID array, a random access memory (RAM), or a read-only memory (ROM).

### Record Management Process:

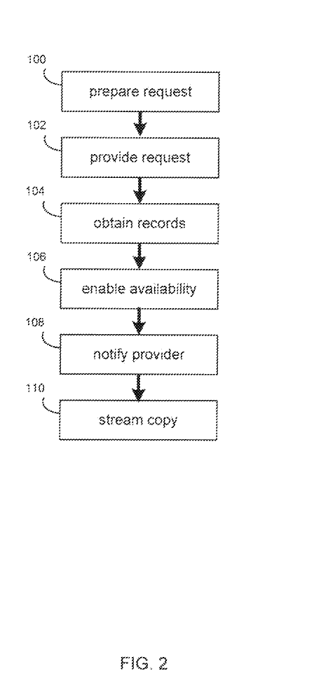

Referring also to FIG. 2 and as discussed above, record management process 10 may prepare 100, on behalf of second medical services provider 18, request 14 for one or more medical records 20 from first medical services provider 16. Request 14 may be provided 102 to first medical services provider 16. Medical records 20 may be obtained from first medical services provider 16, which may be made available 106 to second medical services provider 18.

As discussed above and for illustrative purposes, assume that a patient was being treated by first practitioner 16 (e.g., a general purpose practitioner) and, during a routine physical, a chest X-ray is performed and an anomaly appears on the X-ray. During the course of treatment, first practitioner 16 may generate various medical records, such as text-based medical records, image-based medical records, and/or computer file-based medical records, examples of which may include but are not limited to medical charts, X-rays, CAT scans, contact information, familial information, insurance information, ailment and treatment information, genealogy/family history information, three-dimensional rendered images assembled from individual CAT scan images, and EEG/EKG waveforms, for example). Further, assume that upon detecting the anomaly on the X-ray, first practitioner 16 refers the patient to second practitioner 18 (e.g., an oncologist).

Upon the patient arriving at second practitioner 18, second practitioner 18 may want to examine all or a portion of the patient's medical records (e.g., the medical records generated by first practitioner 16). Second practitioner 18 may contact (via e.g., online request, email, facsimile transmission, or telephone) third party 22 to request copies of the patient's medical records from first practitioner 16. An example of third party 22 is eHealth Global Technologies of Rochester, N.Y.

When second practitioner 18 contacts third party 22, second practitioner 16 may be required to authentic their identity and/or be an established customer of third party 22. For example, second practitioner 18 may be required to provide third party 22 with one or more unique identifiers assigned to second practitioner 18, examples of which may include but are not limited an account number, a customer number, a password, and a PIN (i.e., personal identification number), for example. Additionally, when contacting third party 22, second practitioner 18 may provide sufficient information to identify the patient and the specific medical records desired. For example, second practitioner 18 may provide third party 22 with e.g., the name of the patient, the address of the patient, the social security number of the patient and/or the birth date of the patient, for example. Additionally, second practitioner 18 may define the specific medical records desired from first practitioner 16. Continuing with the above stated example, second practitioner 18 may request from first practitioner 16 (through third party 22) any and all medical records relating to the anomaly discovered in the patient's chest X-ray.

Once the request (e.g., the online request, the telephone request, the email request and/or the facsimile request, for example) is received from second practitioner 18, third party 22 may prepare 100 request 14 for submission to first practitioner 16. The format of request 14 may vary depending on the preferences/needs of first practitioner 16.

Examples of request 14 may include but are not limited to an electronic request (e.g., an email), a paper-based request (e.g., a facsimile), and a voice-based request (e.g., a telephone call).

If request 14 is an electronic request, request 14 may be prepared 100 by user 32 via client application 58. As discussed above, examples of administrative application 58 may include but are not limited to a web browser application (e.g., Microsoft Internet Explorer™ and Netscape Navigator™), an email client (Microsoft Outlook™, Lotus Notes™, and Novell Groupwise™) or a specialized interface. When preparing 100 request 14, an electronic request template (not shown and populatable by client application 58) may be used to define the data fields required for a complete request. For example, the electronic request template may include a patient name field, a patient address field, a patient social security number field, a patient birth date field, and a requested medical records field, for example

If request 14 is a paper-based request, request 14 may be transmitted from e.g., facsimile machine 78 accessible by third party 22 to facsimile machine 80 accessible by first practitioner 16. When preparing 100 request 14, a paper request template (not shown) may be used to define the data fields required for a complete request. For example, the paper request template may include a patient name field, a patient address field, the patient social security number field, a patient birth date field, and a medical records requested field, for example.

While a paper-based request is described above as utilizing a paper request template (not shown) and a pair of facsimile machines 78, 80, other configurations are possible and are considered to be within the scope of this disclosure. For example, one or both of facsimile machines 78, 80 may be coupled to one or more of computers 42, 48 (respectively). Accordingly, facsimile requests may be electronic requests that are prepared 100 using computers 42, 48 and transmitted via analog and/or digital telephone lines (not shown).

Alternatively, user 32 may contact user 38 via a pair of telephones (not shown) accessible by users 32, 38 and make request 14 verbally. When making a verbal request, the information required to properly identify the patient and the requested medical records may be provided verbally (e.g., from user 32 to user 38).

Once request 14 is prepared 100, request 14 may be provided 102 to first practitioner 16. If an electronic request, request 14 is provided 102 to first practitioner 16 when transmitted to e.g., computer 48. If a paper-based request, request 14 is provided 102 to first practitioner 16 when e.g., the facsimile is transmitted from facsimile machine 78 to facsimile machine 80. If request 14 is a verbal request, request 14 is provided to first practitioner 16 when communication is established between e.g., users 32, 38.

Once request 14 is received by first practitioner 16, first practitioner 16 may begin the process of gathering the medical records requested by second practitioner 18 through third party 22. For example and as discussed above, the medical records requested may include text-based medical records, image-based medical records, and/or computer file-based medical records. Accordingly, each of these various types of records may be gathered by first practitioner 16 and prepared for transmittal to third party 22. The manner in which the requested medical records are prepared for transmittal may vary depending on the format in which the records are provided to third party 22. For example, if hard copies of the requested medical records are to be provided to third party 22, the process of preparing the medical records for transmittal may require that first practitioner 16 generate copies for transmittal to third party 22. For example, film-based copies of X-rays may be prepared, photocopies of medical charts may be prepared, and softcopies of computer files (e.g., three-dimensional rendered images assembled from individual CAT scan images, and EEG/EKG waveforms) may be prepared. Once these copies are prepared, the requested medical records 20 may be shipped (via e.g., first class mail or overnight courier) to third party 22 for processing. Alternatively, physical copies of certain medical records may be transmitted (via facsimile) to third party 22. Alternatively/additionally, first practitioner may provide soft copies of the requested medical records to third party 22. For example, image files (e.g., DICOM files, XDS files, PDF files, JPEG files, GIF files, TIF files, EPS files) of e.g., X-rays and medical charts may be prepared and soft copies of computer-based files may be generated. Once prepared, the requested medical records 20 may be transmitted electronically (via e.g., an email attachment) to third party 22.

Once third party 22 obtains 104 the requested medical records 20 from first practitioner 16, third party 22 may process requested medical records 20 to enable availability 106 of medical records 20 to second practitioner 18. For example, if the requested medical records obtained 104 are paper-based medical records, third party 22 may process requested medical records 20 to enable 106 online availability of requested medical records 20. Therefore, paper-based medical records may be scanned and converted into one or more computer files, examples of which may include but are not limited to DICOM files, XDS files, PDF files, JPEG files, GIF files, TIF files, and EPS files. If softcopies of the requested medical records 20 are received by third party 22, the files may be processed to convert them into an acceptable format. For example, an EPS format file may be converted into a PDF format file.

Once the requested medical records 20 obtained 104 from first practitioner 16 are in an acceptable format, the requested medical records 20 may be uploaded to e.g., computer 12 and saved in an area accessible by second practitioner 18. For example, third party 22 may post medical records 20 within a secure area of computer 12 so that medical records 20 may be accessed by second practitioner 18.

Third party 22 may notify 108 second practitioner 18 of the availability 106 of medical records 20. Notification 64 may be generated and provided to second practitioner 18 by e.g., computer 12 or computer 42. For example, once the requested medical records 20 are received and posted by third party 22, notification 64 may be automatically generated and provided to second practitioner 18. Examples of notification 64 may include, but are not limited to, an email, as facsimile transmission and a telephone call.

When notifying second practitioner 18 of the availability of requested medical records 20, notification 64 may define the manner in which the requested medical records may be obtained by second practitioner 18 (and any required passwords). For example, if all requested medical records for all patients of a particular practitioner (e.g., second practitioner 18) are placed in a secure remotely-accessible common directory in computer 12, notification 64 may simply instruct second practitioner 18 to check their secure directory for requested medical records 20. Alternatively, if the requested medical records 20 are placed in a unique directory, notification 64 may define the path (e.g., a uniform resource locator) to the unique directory and provide any required passwords needed to access medical records 20. Alternatively and to enhance security, the required password may be provided in a separate notification or (alternatively) by telephone/first class mail).

As discussed above, computer 12 may execute a web server application that allows for HTTP access to computer 12 via network 24. Accordingly, computer 12 may serve a web-based portal (not shown) for second practitioner 18. Therefore, notification 64 may notify second practitioner 18 that requested medical records 20 are now available on e.g., computer 12. When accessing the web-based portal (not shown), second practitioner 18 may be presented with a plurality of links that point to various medical records available for various patients. For example, the web-based portal (not shown) may include a link that allows second practitioner 18 to access medical records 20 via e.g., computer 12.

Once notified 108, the manner in which second practitioner 18 obtains the requested medical records 20 may vary depending on the preferences of third party 22, the patient and/or second practitioner 18. For example, a copy of the requested medical records 20 may be downloadable from computer 12 to e.g., computer 46.

Alternatively, downloading may be prohibited and requested medical records 20 may only be streamed from computer 12 to e.g., computer 46. Typically, when requested medical records 20 are streamed from e.g., computer 12 to computer 46, a copy of requested medical records 20 is not permanently retained on computer 46. Examples of client application 62 that allow for such data streaming may include, but are not limited to: Citrix Access Gateway™ available from Citrix Systems of Fort Lauderdale, Fla.; and EasyViz™ available from Medical Insight A/S of Hedehusene, Denmark.

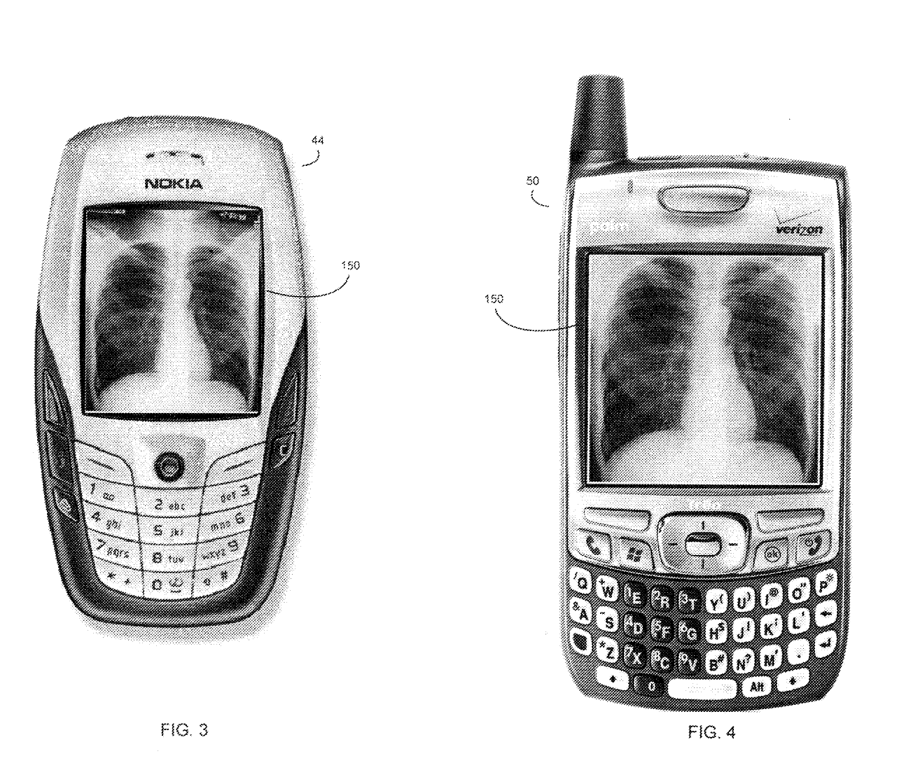

In addition to requested medical records 20 being accessible via e.g., computer 46, requested medical records 20 may be available via one or more mobile devices, examples of which may include but are not limited to cellular telephone 44 and personal digital assistant 50. As discussed above, cellular telephone 44 and personal digital assistant 50 may execute client applications 72, 74 (respectively) to facilitate access to record management system 10, receive notification 64 and view medical records 20 stored on e.g., computer 12. Accordingly, second practitioner 18 may use cellular telephone 44 to access e.g., image 150 of an X-ray included within requested medical records 20 (as shown in FIG. 3) and/or second practitioner 18 may use personal digital assistant 50 to access image 150 of an X-ray included within requested medical records 20 (as shown in FIG. 4).

A number of implementations have been described. Nevertheless, it will be understood that various modifications may be made. Accordingly, other implementations are within the scope of the following claims.

What is claimed is:

1. A method of managing medical records comprising:
preparing, on behalf of a second medical services provider, a request for one or more medical records from a first medical services provider;
providing the request to the first medical services provider;
obtaining the one or more medical records from the first medical services provider; and
enabling the availability of the one or more medical records to the second medical services provider.

2. The method of claim 1 wherein the request is an electronic request and providing the request includes:
sending the electronic request to the first medical services provider.

3. The method of claim 1 wherein the request is a paper-based request and providing the request includes:
sending the paper-based request to the first medical services provider.

4. The method of claim 1 wherein the one or more medical records include one or more text-based medical records.

5. The method of claim 1 wherein the one or more medical records include one or more image-based medical records.

6. The method of claim 1 wherein the one or more medical records includes one or more computer file-based medical records.

7. The method of claim 1 wherein enabling the availability includes:
enabling the availability of an electronic copy of the one or more medical records to the second medical services provider.

8. The method of claim 7 further comprising:
streaming the electronic copy of the one or more medical records to the second medical services provider.

9. The method of claim 7 further comprising:
notifying the second medical services provider of the availability of the one or more medical records obtained from the first medical services provider.

10. The method of claim 9 wherein notifying the second medical services provider includes:
providing the second medical services provider with a link to an electronic copy of the one or more medical records.

11. The method of claim 1 wherein the first medical services provider is a general clinician.

12. The method of claim 1 wherein the second medical services provider is a specialized clinician.

13. A method of managing medical records comprising:
preparing, on behalf of a second medical services provider, a request for one or more medical records from a first medical services provider;
providing the request to the first medical services provider;
obtaining the one or more medical records from the first medical services provider; and
enabling the availability of an electronic copy of the one or more medical records to the second medical services provider.

14. The method of claim 13 further comprising:
notifying the second medical services provider of the availability of the electronic copy of the one or more medical records obtained from the first medical services provider.

15. The method of claim 14 wherein notifying the second medical services provider includes:
providing the second medical services provider with a link to the electronic copy of the one or more medical records.

16. The method of claim 13 further comprising:
streaming the electronic copy of the one or more medical records to the second medical services provider.

17. A method of managing medical records comprising:
preparing, on behalf of a second medical services provider, a request for one or more medical records from a first medical services provider;
providing the request to the first medical services provider;
obtaining the one or more medical records from the first medical services provider; and
notifying the second medical services provider of the availability of the one or more medical records obtained from the first medical services provider.

18. The method of claim 17 wherein the request is an electronic request and providing the request includes:
sending the electronic request to the first medical services provider.

19. The method of claim 17 wherein the request is a paper-based request and providing the request includes:
sending the paper-based request to the first medical services provider.

20. The method of claim 17 further comprising:
enabling the availability of the one or more medical records to the second medical services provider.

21. The method of claim 17 wherein notifying the second medical services provider includes:
providing the second medical services provider with a link to an electronic copy of the one or more medical records.
